(19) United States
(12) Patent Application Publication
(10) Pub. No.: US 2025/0322814 A1
(43) Pub. Date: Oct. 16, 2025

(54) Percussion Instrument Positioning System

(71) Applicant: Randall May International Incorporated, Irvine, CA (US)

(72) Inventor: Randall L. May, Irvine, CA (US)

(21) Appl. No.: 19/177,418

(22) Filed: Apr. 11, 2025

Related U.S. Application Data
(60) Provisional application No. 63/634,329, filed on Apr. 15, 2024.

(51) Int. Cl. G10D 13/10; F16M 11/20; F16M 11/26

(52) U.S. Cl. CPC G10D 13/28; F16M 11/2014; F16M 11/26; F16M 2200/022; F16M 2200/027; F16M 2200/08

(57) ABSTRACT

A knuckle assembly has a mounting base mounted on a vertical support structure. The mounting base is vertically repositionable along the vertical support structure. At least one knuckle is supported on the mounting base. The at least one knuckle is configured to couple to a percussion instrument. The at least one knuckle is rotationally repositionable with respect to the vertical support structure.

### CROSS REFERENCE TO RELATED APPLICATION

This application claims priority to U.S. Provisional Application No. 63/634,329 filed on Apr. 15, 2024, the entire contents of which are hereby expressly incorporated by reference herein.

This application is related to U.S. application Ser. No. 18/066,164 filed on Dec. 14, 2022, which claims priority to U.S. Provisional Application No. 63/289,990, filed Dec. 15, 2021; and to U.S. application Ser. No. 18/933,892, filed Oct. 31, 2024, the entire contents of each which are hereby expressly incorporated by reference herein.

### BACKGROUND OF THE INVENTION

It is known that percussion stands “walk” when their associated instruments (e.g., cymbals, drums, etc.) are played. Such walking occurs due to the impact energy applied to the instrument, which causes the legs of the stand to lift from the ground (or other support surface). The typical solution to mitigating stand walking is to construct the stands from steel and with a radially larger base (e.g., via longer legs). The steel construction tends to withstand the impact energy, and the density/weight of steel tends to resist the lifting of the legs. These steel stands, however, are large and heavy, and are therefore difficult to transport and are not able to be effectively setup in small areas (e.g., on smaller drum riser footprints), which consequently requires additional repositioning the instrument and/or stand. These drawbacks contribute to increased setup time and pre-performance fatigue on working percussionists.

Typical instrument stands and/or associated instrument support structures connecting the instrument to the stand also lack the ability to easily reposition instruments freely between held-in-place trial playing positions (in the x-y-z and rotational axes) without locking-in the trial position as the playing position. Rather, while typical stands and/or support structures permit repositioning, such stands and/or support structures do not hold the trial position in place without locking positions in place while the performer returns to the seated playing position (a.k.a. performing position) to confirm the position as an appropriate playing position. To the contrary, in order to hold trial playing positions in place, it is necessary to lock the positions in as if it were the preferred playing position. Several trial attempts may be needed in order to find the appropriate or preferred playing position. Each locking and unlocking cycle requires the application of significant torque. This requirement to lock and unlock for each trial position can be uncomfortable and fatiguing for the performer, particularly for the performer's hands.

Typical instrument stands also lack positive locking telescoping tubes and/or instrument support structures that maintain a secured playing position of the instrument and are able to remain secured during high energy performances without the need for the performer to lock-in the playing position using very high levels of significant torque. While typical stands and/or support structures may, with enough applied torque, remain secured during high energy performances, the application of such torque can be uncomfortable and fatiguing for the performer, particularly for the performer's hands. Also, while some current instrument stands provide indexed memory stops fixed on telescoping tubes, further adjustments to the memory stops are burdensome when additional vertical and/or rotational instrument positioning is required.

It is therefore an object of the disclosure to provide a percussion instrument and instrument support structure, as well as related systems and methods, which address these shortcomings. Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

The features, objects, and advantages of the present invention will become more apparent from the detailed description, set forth below, when taken in conjunction with the drawings, in which like reference characters identify elements correspondingly throughout.

### BRIEF DESCRIPTION OF THE DRAWINGS

FIG. 1 is an isometric view of upper percussion support stand with an instrument positioning system in accordance with at least one embodiment;

FIG. 2 illustrates aspects of the instrument positioning system in accordance with at least one embodiment;

FIGS. 3 and 3A-3D illustrate aspects of the instrument positioning system in accordance with at least one embodiment;

FIG. 4 illustrates further aspects of the instrument positioning system in accordance with at least one embodiment;

FIG. 5 illustrates additional aspects of the instrument positioning system integrated with cymbal/drum supports in accordance with at least one embodiment;

FIG. 6 illustrates additional aspects of the instrument positioning system integrated with cymbal/drum supports in accordance with at least one embodiment;

FIG. 7 illustrates aspects of the instrument positioning system transitioning to a folded configuration;

FIG. 8 illustrates aspects of the instrument positioning system in the folded configuration;

FIG. 9 illustrates additional aspects of the instrument positioning system;

FIGS. 10 and 10A-10B illustrate additional aspects of the instrument positioning system; and

FIG. 11 illustrates further aspects of the instrument positioning system.

### DETAILED DESCRIPTION OF THE DRAWINGS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In the following detailed description and corresponding figures, numerous specific details are set forth in order to provide a thorough understanding of the present invention. However, it should be appreciated that the invention may be practiced without such specific details. Additionally, well-known methods, procedures and components have not been described in detail.

The disclosure is generally directed to an instrument stand with an articulating instrument support structure. The stand and/or support structure is/are configured to be repositioned in real time and to hold a provisional or trial position without the need to secure stand and/or support structure locking locations. As referred to herein, repositioning in the x-y-z axes, or axial positioning, is intended to mean a linear repositioning, whereas repositioning in the rotational axes, or rotational positioning, is intended to mean a yaw-pitch-roll repositioning. The provisional x-y axial positions gravity held (i.e., supported) in place can be thereafter locked in place with matching radius cam(s) engaging cam lock draw bolt(s) such that the cam does not deform or blemish telescoping tube or axles being secured.

The axial and rotational positioning of the support instrument may be further assisted with interconnected mechanical assist, via gas spring. The z-axis vertical position is held (i.e., supported in place) with the mechanical assist, which may be gas spring assists with a work force similar to that of the supported instrument's static weight. The articulating instrument support structure positions the instrument's static weight distal from the stand's vertical axis. This off-axis (cantilevered instrument weight) temporally binds the Z axis and stalls the gas spring's deployment force thus holds vertical provisional position. If the provisional position is still too low, the performer is able to apply a small amount of hand support to the instrument to relieve the cantilevered instrument's weight, resulting in a higher trial position. Upon confirming the desired provisional x-y-z axes and/or axial positioning, the positions are locked in place with matching radius cam(s) engaging cam lock draw bolt(s) such that the cam does not deform or blemish telescoping tube or axles being secured.

Where the mechanical assist is intergraded to the telescoping height and rotation positioning, the telescoping housing member of the gas spring can be eliminated to further reduce weight. The gas spring can thereby utilize the matching radius cam that does not deform or worse puncture the pressurized gas spring being secured longitudinally and rotationally in place.

Gas springs are under high pressure when pressurized with nitrogen in manufacturing process, thus are not intended for the pressurized cylinder to be point loaded to stop/secure the travel position. The extending piston rod exiting the pressurized gas cylinder is also not to be point loaded to stop/secure the travel position. With the aforenoted pressurized body and exiting piston rod typical common construction, gas spring applications do not offer nor recommend interrupting the deployment with a point loaded stop-lock. Obviously, a point loaded stop could puncture the highly pressurize cylinder (nitrogen) that could be potentially hazardous and/or render the gas spring nonfunctional. In contrast, if a point load is applied to the exiting piston rod and exerts enough force to stop the deployment of the rod, it is exposed to generating a bur that would damage the seals inside the pressurized cylinder, thus losing pressurization rendering the gas spring nonfictional.

The stop/secure cam structure disclosed herein eliminates the aforenoted potential damage and further allows for deletion of the telescoping or fixed housing/tube encompassing the mechanical assist/gas spring. The stop/secure cam has a matching radius to the pressurizer cylinder and/or piston rod thus spreading the load(s) and provides greater surface area to stop secure the deployment with no damage to either gas spring components with minimal stop torque force.

It is further understood support legs of the instrument support stand may also have gas springs with equally like force of deployment and associated stroke. The gas springs are deployed by releasing associated cam lock draw bolts inside cam housings to self-level the stand. The deployment of the self-leveling gas springs housed in said support legs are fitted with sphere/ball or radius like rubber feet.

It is further contemplated a leg deployment gas spring housed in the stand's lower base vertical tube can be released to automatically deploy the stands support legs and locked in position. U.S. patent application Ser. No. 18/933,892, entitled Universal Modular Mechanical Assist Percussion Instrument Carrier, filed Oct. 31, 2024, and incorporated herein by reference in its entirety, describes interconnecting the housed gas spring to deploy slidable longitudinal leg collars.

When the gas spring is used to deploy manifold collars interconnected to the support legs, an optional constructed gas spring has an internal integrated compression spring that provides additional launch force to work in tandem with gas spring work force. The launch spring is preferred to be shorter in length than the full deployment stroke of the gas spring as to primarily provide addition launch force while mitigating compression force when returning to the stored position. In some embodiments, all support legs could be of equal length and manifolded together as when folded up for transport and deployed all to together for deployment set up. In addition, one gas spring could have a deviated stroke length to position the vertical axis of the stand off-axis by design.

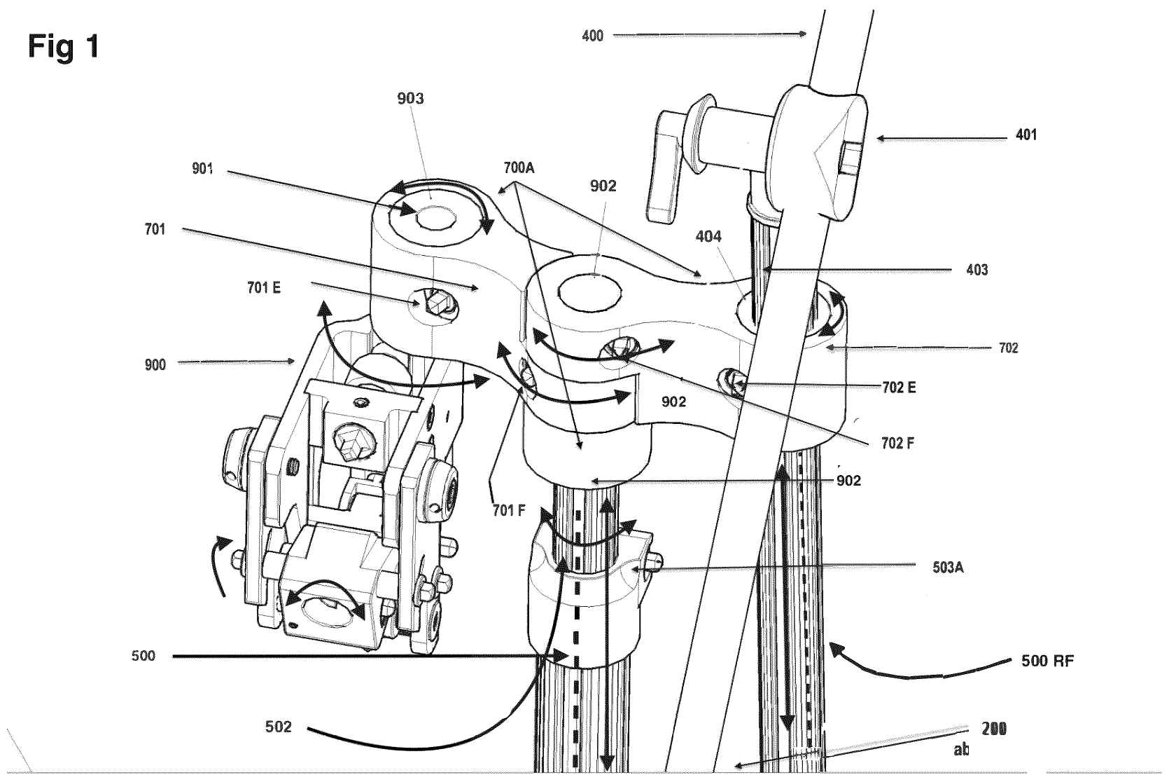

FIGS. 1-4 illustrate an articulating modular universal percussion instrument cymbal-drum positioning knuckle assembly 700A. The knuckle assembly 700A includes cam/lock swivel arm(s) 701 and/or 702 (i.e., knuckles) supported on a mounting base 700. The cam/lock swivel arm(s) 701 and/or 702 are vertically and rotationally repositionable. The knuckle assembly 700A preferably does not distort or mar tube/rob mounting posts 901, 901A, 901B, 502 and/or 403 when engaging in a locked position. The knuckle assembly 700A further allows performer real time provisional or test positioning instrument adjustments. The knuckles 701, 702 are gravity fed via mirrored mating pocketed fulcrums 701PF, 702PF that allow rotation to desired performing location. Thus, the test position may be temporarily maintained as the drummer returns to a seated performing position to evaluate instrument positioning, prior to engaging cam draw lock bolt(s) 701E, 701F, 702E, 702F and 503E to a locked/secured position.

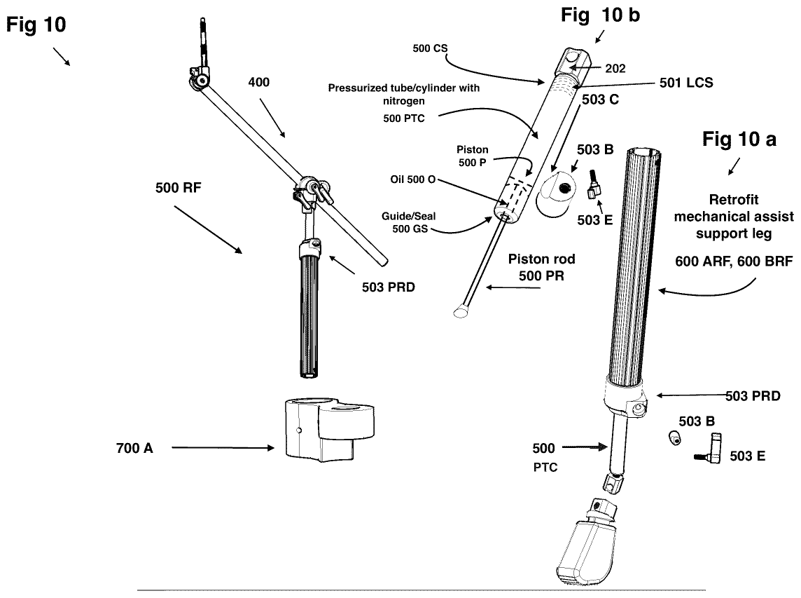

The knuckle assembly 700A also includes cam(s) 701A, 701B, 702A and 702B with matching radii of tube/rod 701C, 701H, 702C and 702H to radii of mounting posts 901, 403 and bi-circumferential mounting posts 902. The mounting posts 901 and 403 may be of different diameters. Thus, longitudinal cavities 903 and 404 that receive the mounting posts 901 and 403 will have associated matching diameters along with associated cams having matched tube/rod radius, providing a non-marking secure positive locked engagement with minimal torque applied to cam draw/lock bolt 701E, 702E. Cam 503B has matching tube/rod radius for telescoping housing for mechanical assts 500CS, as shown in FIG. 10.

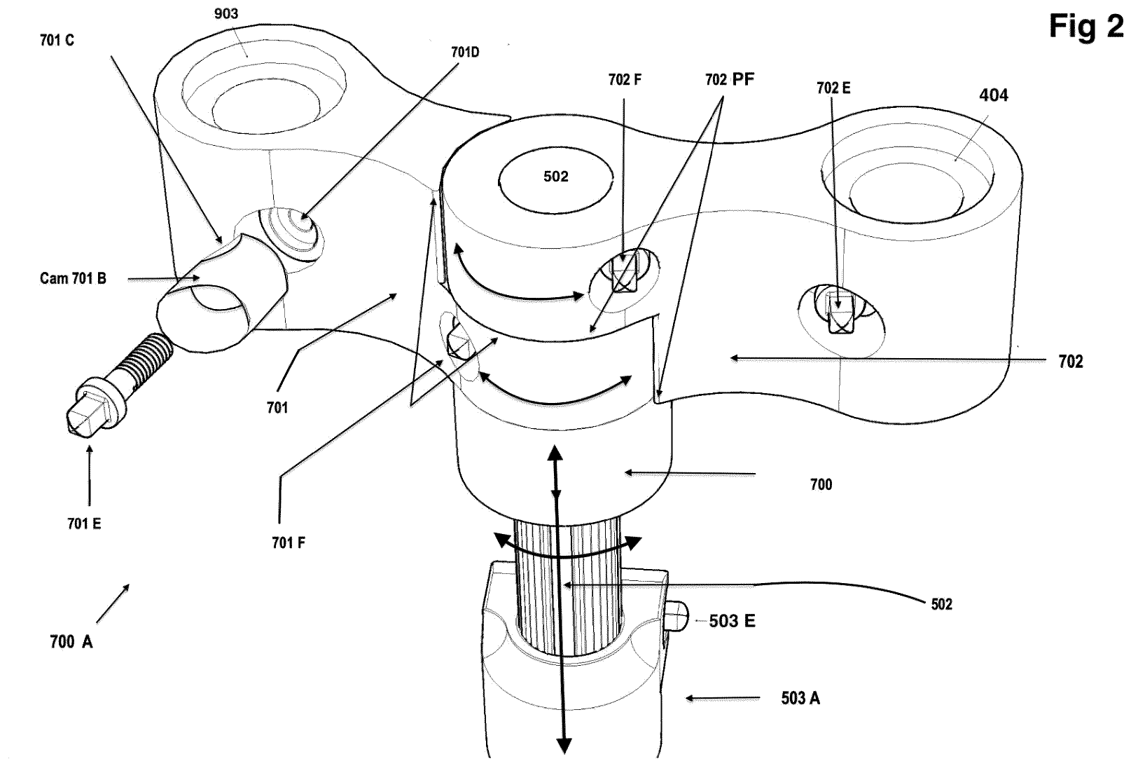

FIG. 2 shows the knuckle assembly 700A. The knuckle assembly 700A comprises articulating modular knuckles 701, 702 resting on mounting base 700. The knuckles 701, 702 have mirrored mating pocketed fulcrums 701PF, 702PF allowing rotation to desired performing location around vertical axis of telescoping housing 502 and secured in place with draw/lock bolt/s 701F, 702F. The mounting base 700 may be repositioned longitudinally (e.g., lower) to further extend telescoping housing 502, accepting additional modular knuckles 701, 702 (e.g., more than two shown in FIG. 2). Vertical mount positioning of the percussion instruments posts 901, 403 are secured with cam draw/lock bolt 701E, 702E. Cam 701B has matching radius 701C (for tube/rod post 901) and thru hole to allow draw/lock bolt 701E to pass through threading into cam housing 701D.

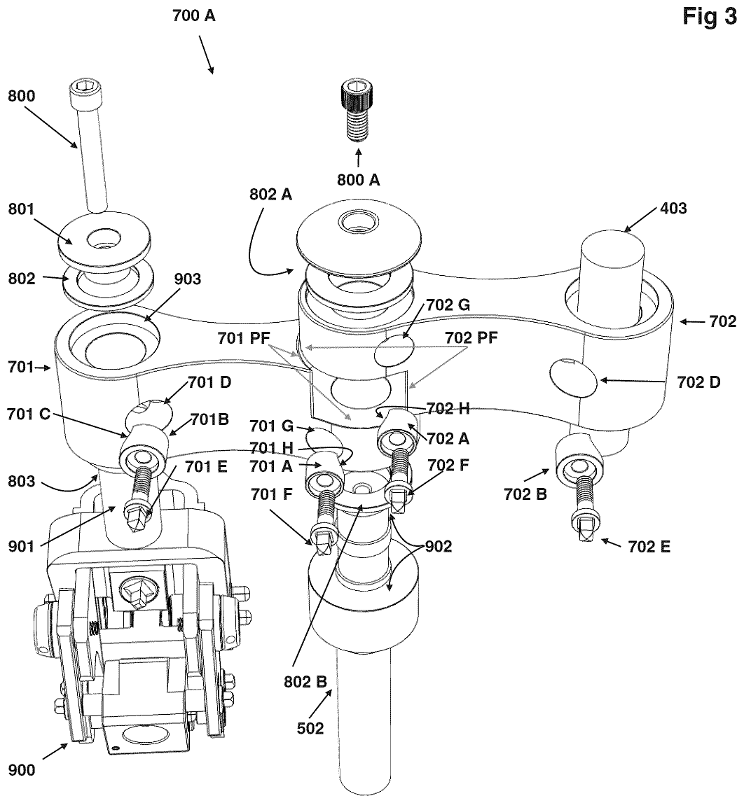

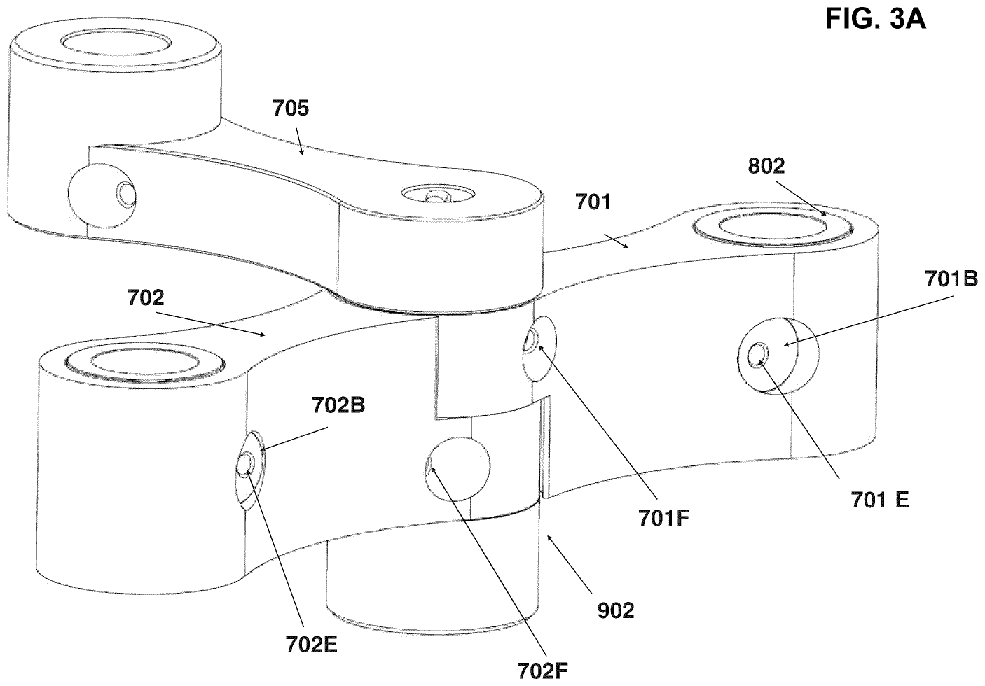

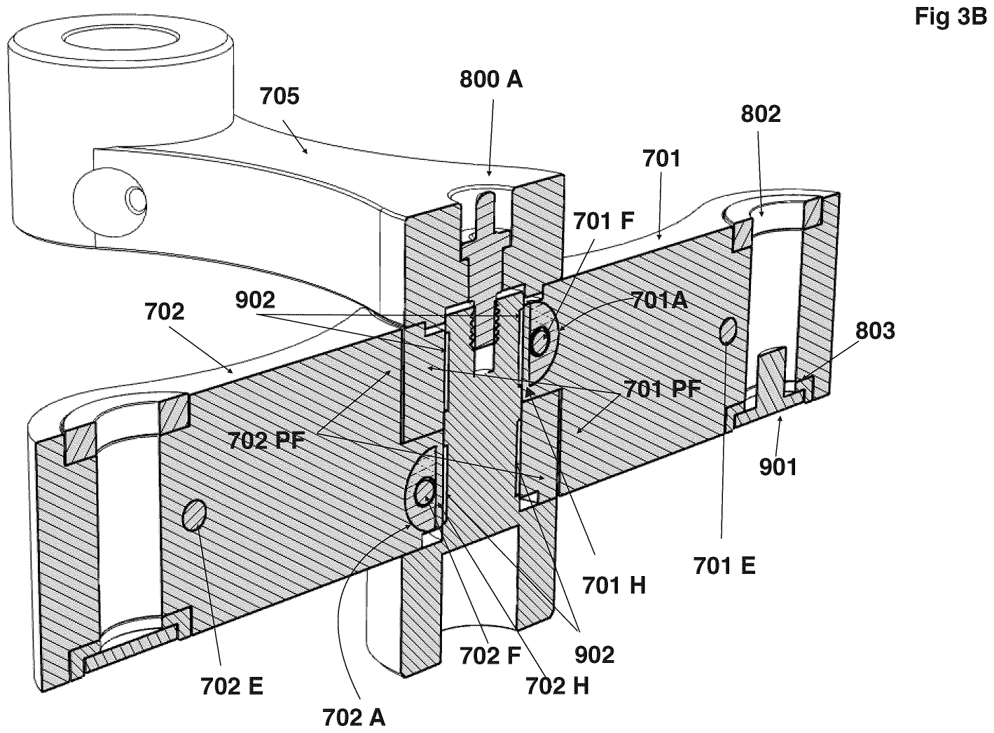

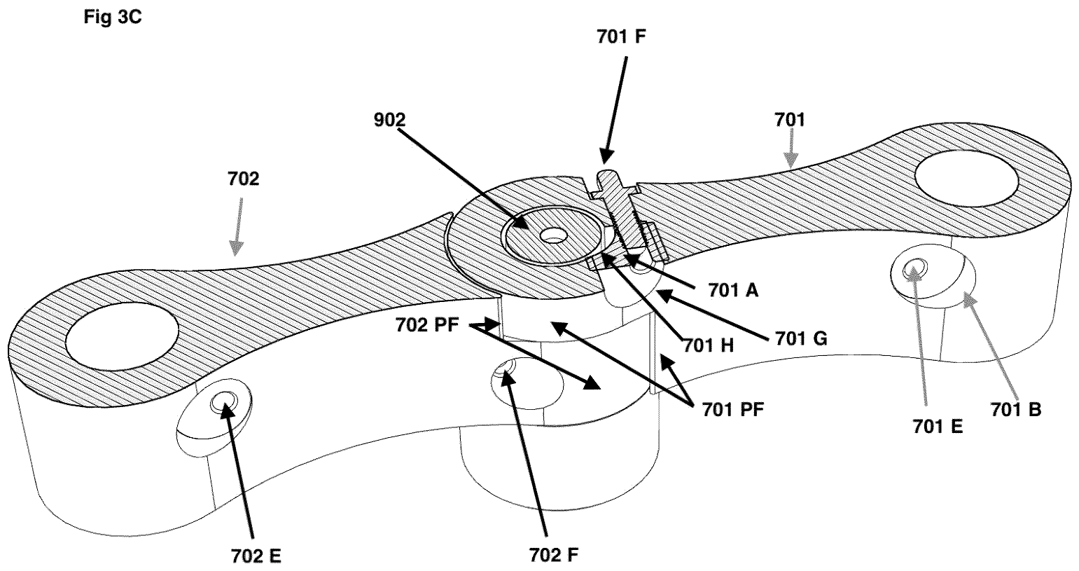

FIG. 3 shows an exploded view of the knuckle assembly 700A. The knuckles 701, 702 interconnect to a bi-circumferential rotational mounting post 902 that allows for independent rotation/positioning of knuckles 701, 702 and further allows for the knuckles 701, 702 to be secured in position with cam draw lock bolt 701F, 702F. The knuckles 701, 702 include respective instrument support longitudinal cavities 903 that receive drum supporting hardware 900. Exemplary drum supporting hardware 900 is described in U.S. Pat. No. 10,249,273, entitled “Magnetic Drum Suspension Apparatus,” filed Jan. 16, 2018; U.S. Pat. No. 10,818,276, entitled “Drum Suspension Apparatus,” filed Mar. 4, 2019; and U.S. Pat. No. 11,335,307, entitled “Drum Suspension Apparatus,” filed Sep. 24, 2020.

In at least one embodiment, a cymbal percussion boom arm 400 and/or drum suspension apparatus 900 may be interconnected via a mounting support post 901 (FIG. 1). The mounting support post 901 is interconnected to cavity 903 with mounting post fastener 800. The cavity 903 has a counter bore to accept aluminum alignment shoulder washer 801 that rests on a bearing washer 802, which can be constructed of Teflon or other similar material. Thus, drum supporting hardware 900 can freely rotate independently and/or simultaneously with the knuckle rotation with respect to posts 901 and 902. The bi-circumferential rotational mounting post 902 is interconnected to cavities 701PF, 702PF with mounting post fastener 800A. The cavities 701PF, 702PF have counter bores to accept bearing washers 802A, 802B.

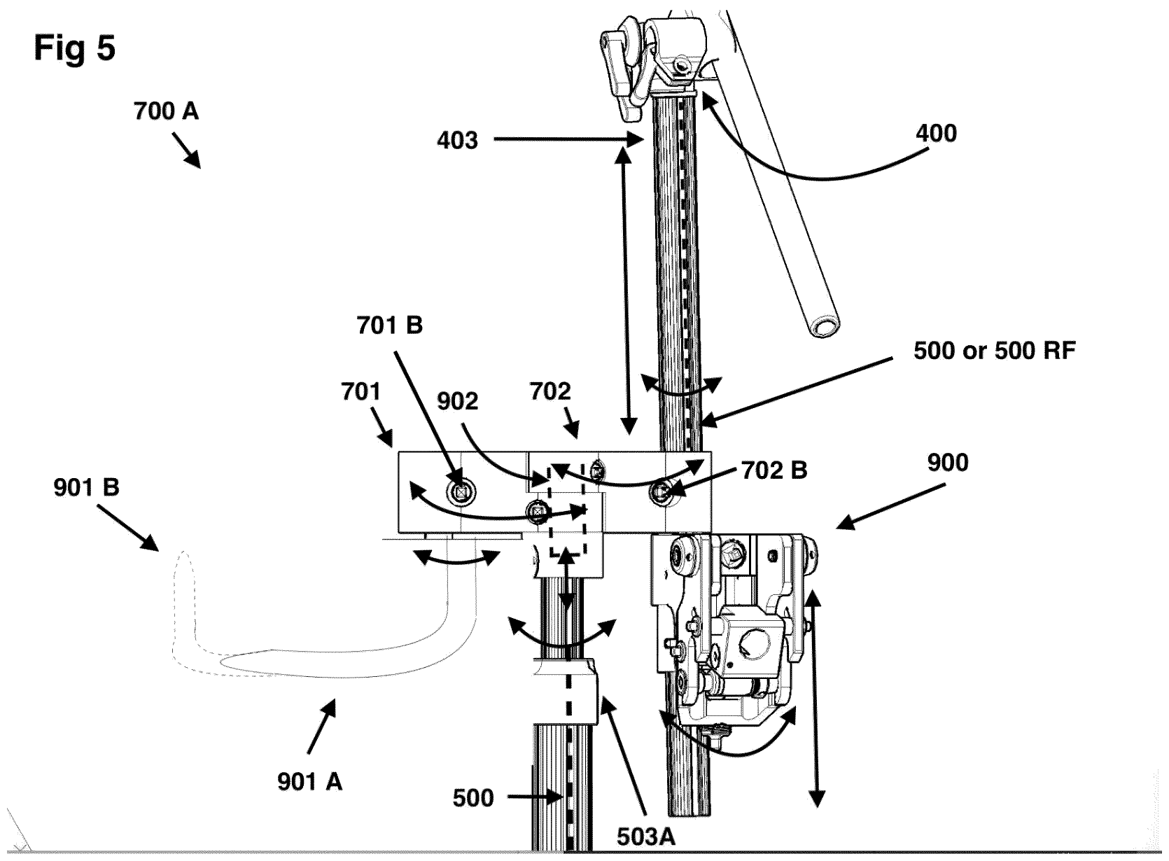

In some embodiments, at least one knuckle 701, 702 has instrument support longitudinal cavity 404 to receive drum supporting suspension hardware 900 or traditional ridged mounting L/U rods 901A or 901B on articulating knuckle 701, 702 (FIG. 5). In some embodiments, at least one knuckle 701, 702 can be configured for either cymbal supporting hardware 400 or drum supporting suspension hardware as in 900 (FIG. 1).

It should be understood ridged or suspension type mounting hardware can be used. Drum supporting hardware mounting post 901 can be interconnected with traditional ridged non-suspension mounting L rod 901A and/or mounting U 901B to support percussion instruments (FIG. 5). A performance energy absorbing percussion structure 200 may further be included, as shown, for example, in U.S. application Ser. No. 18/066,164, entitled “Energy Absorbing Percussion Instrument Stand,” filed Dec. 14, 2022.

It should be further understood retrofit mechanical assist support leg 600ARF, 600BRF (FIGS. 10a, 10b) can also be implemented in tandem or independently to enhance instrument suspension properties both in absorbing energy and enhancing sonic properties.

At least one knuckle 701, 702 can also be configured for cymbal supporting hardware 400, 403 (FIG. 5) and freely rotate independently and/or simultaneously, thus articulating the knuckle on post 902, 403. It should be understood knuckle assembly 700A can support like instrument support structures or dissimilar instrument support structures. In addition, as shown in FIGS. 1 and 10, a retrofit mechanical assist instrument support appendage 500RF and/or 500 mechanical assist embodiments can be implemented to further expand articulating hands-free instrument positioning. Vertical mounting positioning post 403 is interconnected to cavity 404 with cam 702B and cam lock draw bolt 702E. The cavity 404 has a counter bore to accept bearing washers as in 802 and 803 to allow frictionless articulation.

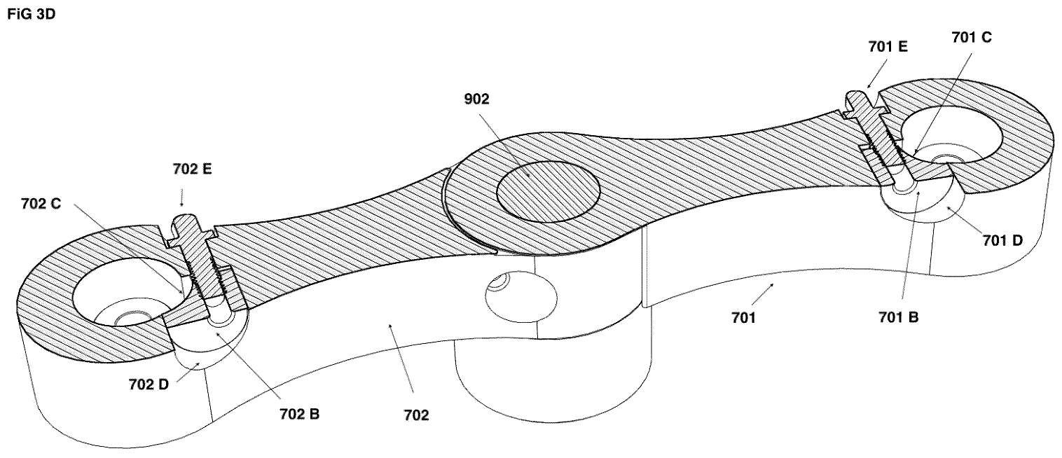

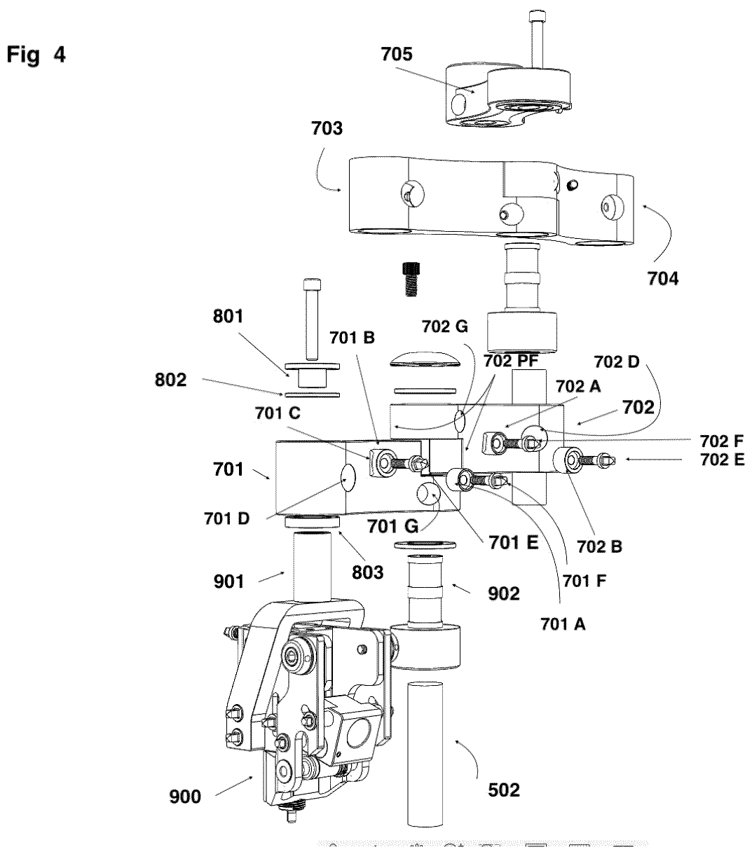

FIG. 4 shows further detail in exploded view of the knuckle assembly 700A with stackable retrofit knuckles 703, 704 and 705. It should be understood one or more knuckles can be implemented either in single or paired embodiments supported on one or more knuckles.

FIG. 5 shows combination instrument cymbal-drum supports 400, 900 interconnected to vertical mounting positioning post 403 and/or mechanical assist 500 or 500RF (also shown in FIG. 10) supported in knuckle 701 and/or 702 and secured with 701B, 702B and 701E, 702E. It should be noted that one or more mechanical assist can be further interconnected with one or more knuckles further expanding vertical positioning and rotational positioning around the mechanical assist vertical axis independent form the knuckles vertical and rotational axis. The preferred mechanical work force is primarily to assist with the vertical positioning and support the instrument hands-free without further vertical movement (maintaining said vertical position) and further allowing rotational positioning thus maintaining both vertical and rotational position hands free. As previously described the articulating knuckles work about both their multi rotational axis and in tandem with the mechanical assists vertical and rotational axis.

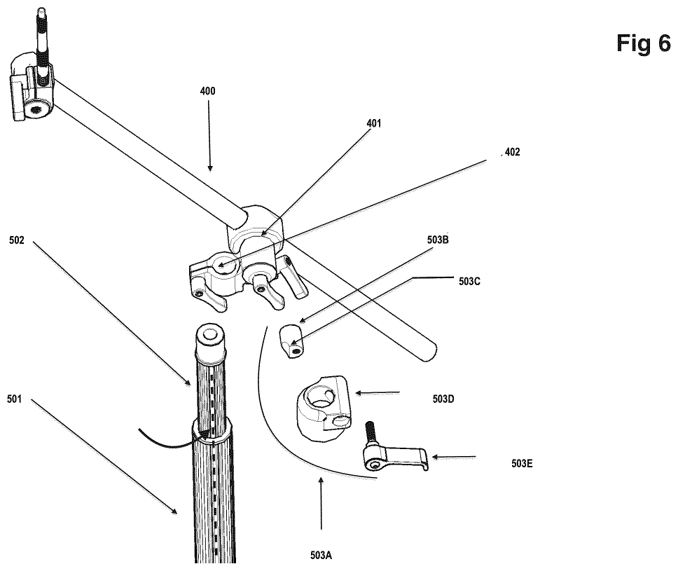

FIG. 6 illustrates cam structure implemented in both percussion tilt 401 and cam 402 quick disconnect for transport and/or substituting different percussion instrument to be supported on mounting structure 403 (FIG. 5) and/or telescoping housing for mechanical assists 502 or mechanical assists 500RF (FIG. 10). Exploded components of cam lock assembly 503A along with further transport configuration with separating cam 401 and cymbal boom cam arm tilt 402 all utilizing cam lock assemblies. The cam lock assembly 503A is a preferred embodiment as to not distort or deface telescoping housing 502 (for internal mechanical assist gas spring 500) when locking/securing in position. It is further contemplated that telescoping housing 502 could be omitted, and only the pressurized body/cylinder (of gas spring) would telescope to interconnect with the instrument or supporting hardware to be positioned and locked with 503A. The cam 503B has matching radius to engage telescoping housing 502 (for mechanical assist, gas spring) or gas spring 500. In addition to said matching radius, cam tube matching radius 503C may have matching longitudinal profile/s of 502 to further resist twist/torque. The cam lock draw lever 503E threads into cam 503B and draws cam 503B to a locking frictional stop grip.

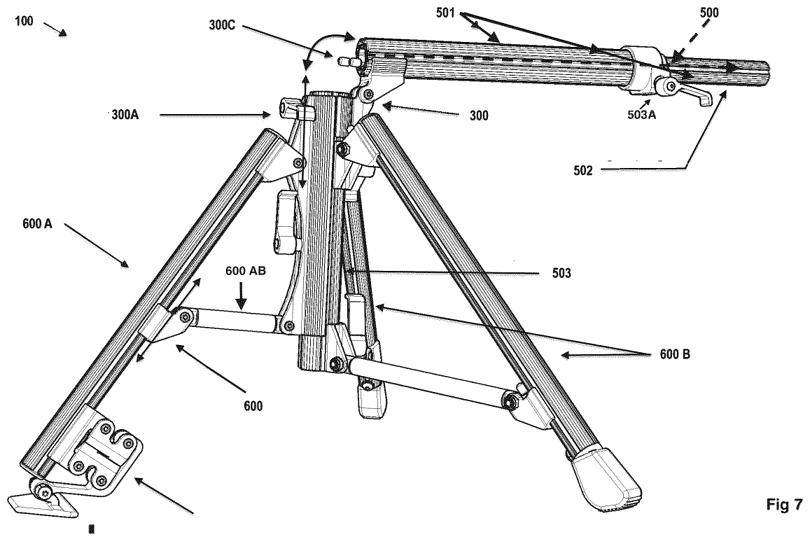

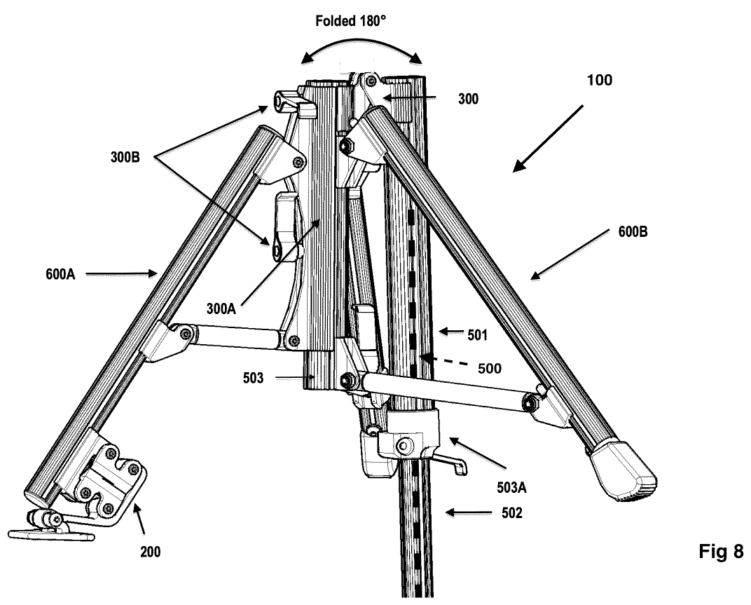

FIGS. 7 and 8 illustrate transport percussion mechanical assists folding/separating base vertical support 503 from housing 501 for internal mechanical assists gas spring 500 interconnected in percussion mechanical assists folding/separating support stand 100. In some embodiments, stand 100 may be equipped with the energy absorbing damper 200, particularly when traditional ridged mounting L shaped or U shaped rods 901A, or 901B supported with articulating knuckle/s 701 (FIG. 5).

The instrument support structure 900, 400, 901A, 90B and/or 500RF (FIGS. 1-5 and 10) is generally configured to interconnect with knuckle assembly 700A. The knuckle assembly 700A is further interconnected to stand 100 that instrument/s are mounted thereon and thereby supported by the percussion instrument stand 100. The instrument support structure may be, for example, a cymbal mount with or without boom arm, a single tom mount, a double tom mound, and combinations thereof, as well as associated components and/or mechanisms, as known in the art.

Exemplary instrument support structures are described in the following applicant's patents, the entire contents of which are incorporated herein by reference: U.S. Pat. No. 7,438,266, entitled Stackable Instrument Stadium Hardware Stand, filed on Jun. 9, 2006; U.S. Pat. No. 7,588,228, entitled Adjustable Tripod Stand, filed on Jan. 16, 2003; U.S. Pat. No. 7,703,725, entitled Adjustable Tripod Stand, filed on Jan. 16, 2003; U.S. Pat. No. 8,633,365, entitled Instrument and Speaker Lift Stand, filed on Dec. 14, 2010; U.S. Pat. No. 9,377,158, entitled Articulating Amplifier Stand, filed on Dec. 14, 2010; U.S. Pat. No. 9,863,573, entitled Instrument and Speaker Lift Stand, filed on Feb. 18, 2010; U.S. Pat. No. 9,881,595, entitled Articulating Amplifier Stand, filed on Feb. 14, 2010; U.S. Pat. No. 10,167,994, entitled Instrument and Speaker Lift Stand, filed on Sep. 26, 2013; U.S. Pat. No. 10,885,888, entitled Mechanical Assist Equipment Support Stand, filed on Dec. 14, 2010; and U.S. Pat. No. 7,718,878, entitled Musical Instrument Stand with Assisted Extension, filed on Sep. 12, 2008 (collectively the “stand patents”). Other exemplary instrument support structures, particularly those having magnetic and non-magnetic suspension features, are shown in the following patents, the entire contents of which are incorporated herein by reference: U.S. Pat. No. 10,818,276, entitled Drum Suspension Apparatus, filed Mar. 4, 2019; and U.S. Pat. No. 10,249,273, entitled Magnetic Drum Suspension Apparatus, filed Jan. 16, 2018 (collectively, the “suspension patents”).

In some embodiments, the main body may be transitioned between a folded position in which the upper body 501 is displaced substantially parallel to the lower body 503, and an unfolded position, in which the upper body 501 is substantially coaxial with the lower body 503, and semi-folded position.

The transport folding mechanical assist system 100 may further include one or more alignment means configured to align the upper body 501 and the lower body 503 so as to be coaxial in the unfolded position. The alignment means may be, for example, one or more: magnets, pins/holes, hooks/loops, snap latches, or any other alignment hardware. In at least one embodiment, the alignment means comprises at least one attractive pair of alignment/pin magnets 300C, whereby the upper body 501 and the lower body 503 are coaxially aligned via the magnetic force resulting from the pair of magnets coming into proximity with each other as the upper main body transitions to the unfolded position. Accordingly, the alignment means may be positioned at matching locations of the upper body and lower body so as to thereby cause the coaxial alignment.

The transport folding mechanical assists system may further include a locking mechanism configured to securely lock the main body in the unfolded position. That is, the main body 501 is locked in the unfolded position sufficiently secure to not transition out of the unfolded position during normal playing use of the percussion instrument stand 100 (i.e., during playing and while set up to play).

In at least one embodiment, the locking mechanism includes a locking collar 300A that is slidable along the lower body 501 and/or the upper body 503 such that the locking collar 300A can be maneuvered between a locking position and an unlocking position. In the locking position, the locking collar 300A abuts the coaxially aligned lower body 503 and upper body 501 that are in the unfolded position, thereby locking the main body in the unfolded position via the abutment.

In the unlocking position, the locking collar 300A has been maneuvered so as to only abut one of the upper body 501 or the lower body 503 (preferably the lower body 503), thereby allowing the upper main body 501 to transition to the folded position. The locking collar 300A may further be secured in position along the main body via one or more fasteners 300B, such as, for example, threaded bolts, snap latches, and other similar hardware.

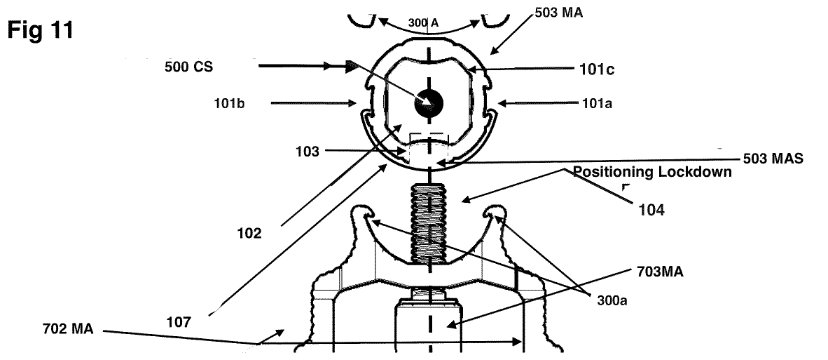

In at least some embodiments, the locking collar 300A may be shaped so as to form a tongue-and groove connection with the main body, which tongue-and-groove connection allows for the aforementioned slide ability. For example, the locking collar 300A may be, in whole or in part, c shaped and may thereby engage corresponding linear grooves 101a, 101b of the main body 501,503 so as to allow for sliding along the lineal grooves (FIG. 11). Additionally, or alternatively, the locking collar 300A may be, in whole or in part, 0-shaped with one or more internal protrusions via which the slidable tongue-and-groove connection may be made. Exemplary collars, the principles of which may be applied to the locking collar, are described in U.S. Pat. No. 7,703,725, referenced herein.

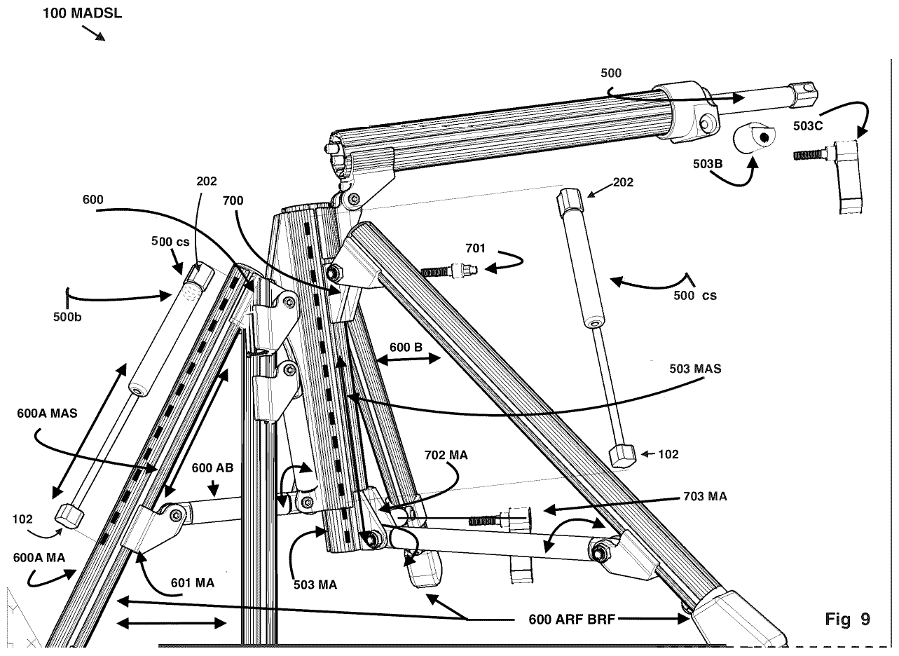

FIG. 9 shows percussion transport mechanical assists folding/separating support stand interconnected with mechanical assist deploying support legs 100MADSL.

It is further contemplated a leg deployment mechanical assists gas spring 500CS is housed in the stand's lower base vertical tube 503MA. Gas spring 500CS is interconnected to travel double collar 702MA thru mechanical assist longitudinal travel slot 503MA can be released to automatically deploy the stands support legs 600B and locked in position with travel double collar release/lock fastener. U.S. patent application Ser. No. 18/933,892, entitled Universal Modular Mechanical Assist Percussion Instrument Carrier, filed Oct. 31, 2024, and incorporated herein by reference in its entirety, describes interconnecting instrument hardware/leg collars.

When the mechanical assist deploying support legs gas spring 500CS is used to deploy single travel collar 601MA, double travel collar 702MA, or a unitary manifold collar (not shown) interconnected to the support legs, an optional constructed gas spring 500CS (FIG. 10b), illustrates an internal integrated compression spring 501LCS that provides additional launch force to work in tandem with gas spring rated work force. The launch spring is to assist with additional force to facilitate energizing the moment of gas spring deploying the support leg/s to supporting position. Special gas spring 500CS with 501LCS launch spring is preferred shorter than the full deployment stroke of gas spring 500CS primarily providing addition launch force while mitigating compression force to store piston rod 500PR retracted/compressed position. It should be understood the stand 100MADSL is illustrated is one preferred embodiment, but all support legs 600AMA and 600B could be of equal length and manifolded together as when folded up for transport and deployed for set up. In addition, if two deployment gas springs 500CS are implemented, one of the two gas springs could have a deviated stroke length to position the vertical axis (of the stand) off axis by design. It is further contemplated if only one gas spring 500CS is interconnected to combined manifold tri travel collar (not shown) deploying all three support legs simultaneously. Nose leg 600A and/or associated leg brace 600AB could be of dissimilar length to position the vertical axis (of the stand) off axis by design.

It is further understood that one or more support legs of the instrument support stand may also have mechanical assists interconnected with the support legs 600A, 600B via mechanical assist retrofit support legs 600ARF, 600BRF having like force of deployment and associated stroke (FIGS. 10, 10a and 10b). The gas springs are deployed by releasing associated cam lock draw bolts 503E inside cam housings 503PRD to self-level the stand. The deployment of the self-leveling gas springs housed in said support legs are fitted with sphere/ball or radius like rubber feet.

FIGS. 9, 10 & 11 illustrate configurations for deploying travel double collar 702MA and/or or travel signal collar 601MA to position associated support legs 600AMA and/or rear support legs 600B to erect the stand. The gas spring 500CS is interconnected to travel double collar 702MA via mechanical assist longitudinal travel slot 503MSA supporting and deploying rear support legs 600B. Torque resistant gas spring base vertical housing 503MA houses mechanical assist 500CS (deploying support legs) is slidably internally interconnected with hollow asymmetric octagon bearing 101C. FIG. 11

A torque resistant gas spring housing 503MA has internal anchor bock bolt threaded into both torque resistant gas spring housing 503MA and gas spring internal anchor block 202. A traveler gas spring bearing 102 is threaded onto opposite end of the gas spring 500CS. The traveler gas spring bearing 102 has a similar profile to (inside) of housing 503MA via hollow asymmetrical octagon profile 101c of torque resistant gas spring housing 503MA. torque resistant gas spring housing 503MA is preferably made of light weight metals i.e. aluminum or magnesium and traveler gas spring bearing 102 is preferably constructed with a machinable polymer with good to excellent lubricity, as with Teflon or Acetal to mitigate drag (friction) in the deployment travel of the gas spring 500CS. The gas spring's 500CS outside diameter is undersized to that of traveler gas spring bearing 102 outside diameter, thus allowing Gas Spring 500CS to deploy or compress without interfering with inside the hollow asymmetrical octagon 101c. The traveler gas spring bearing 102 is also undersized with micro-clearance, typically a few thousandths and further has a horizonal pocket to receive a traveler insert cup 103 (preferably constructed from metal); that receives a positioning lockdown 703MA. The traveler insert cup 103 serves to protect the traveler gas spring bearing 102 from repeated point loading/compression, while engaging the positioning lockdown fastener 104. The positioning lockdown fastener 104 is threaded into travel double collar 702MA and/or 601MA and passes through the gas spring deployment travel slot 503MAS or 600AMA and floats into the traveler insert cup 103; interconnecting both gas spring 500CS and mechanical assist slider travel double collar 702MA and/or slider single collar 601MA interconnected. While the gas spring 500CS is shown in one orientation illustrated leg/s deployment; 500CS could be inverted to deploy the body of gas spring 500PTC as shown in FIG. 10A.

Upon deployment/release of gas spring 500CS with traveler gas spring bearing 102 interconnected with slider travel double collar 702MA, both gas spring bearing 102 and slider travel double collar 702MA collectively travel longitudinally downward thus unfolding rear support legs 600B outward away from stored parallel position with 503MA. In some embodiments, all supporting legs 600A and 600B our manifold together via slider travel triple collar (not shown). Upon deployment/release of gas spring 500CS with traveler gas spring bearing 102 interconnected with travel triple collar, both gas spring bearing 102 and slider travel triple collar (not shown) collectively travel longitudinally downward thus unfolding/deploying all supporting legs 600A and 600B simultaneously to one combined movement. Once fully deployed, the mechanical assist system is further secured with the lockdown fastener 104, 703MA rotated (clockwise) to lock the position of traveler gas spring bearing 102 and travel double collar 702MA and/or travel single collar 601MA. The traveler gas spring bearing 102 with lateral movement (approximately a few thousands) positioning/compressing against the inside of the hollow asymmetrical octagon 101c wall. The positioning lockdown 703MA, 104 also simultaneously draws mechanical assists slider travel double collar 702MA away from the torque resistant gas spring housing 503MAS or 600A MAS engaging dove tail guide track/s 101a and guide boss tracks 300a incorporated in travel double collar 702MA and/or 601MA.

The mechanical assist deploying support leg/s stand 100MADSL may also have optional memory positioning stop 107 (FIG. 11) that is positioned longitudinally on the torque resistant gas spring housing 503MA or 600AMA to mechanically interfere/stop the gas spring 500CS deployment to a preset preferred stop position.

This is beneficial to position the leg(s) to a predetermine spread/radius and/or adjust the vertical axis off center to a predetermine angle assisting with counter balancing instruments supported on a boom and/or cantilevered offline to the CG of the stand.

The following commonly owned patents may be relevant to the understanding of the state of the art as well as the embodiments disclosed herein: U.S. Pat. No. 8,633,365, entitled Instrument and Speaker Lift Stand, filed Dec. 9, 2011, the entire contents and disclosures of which are herein incorporated by reference.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the description and equivalents thereof.

What is claimed is:

1. A knuckle assembly, comprising:
a mounting base configured to be mounted on a vertical support structure, wherein the mounting base is vertically repositionable along the vertical support structure,
at least one knuckle supported on the mounting base, wherein the at least one knuckle is configured to couple to a percussion instrument, and wherein the at least one knuckle is rotationally repositionable with respect to the vertical support structure.

2. The knuckle assembly of claim 1, wherein each knuckle is independently repositionable.

3. The knuckle assembly of claim 1, wherein each knuckle is configured to hold a trial position before being locked into a playing performing position.

4. The knuckle assembly of claim 1, wherein each knuckle comprises:
a distal portion having a distal cavity for securing additional percussion instrument hardware therein; and
a proximal portion having a proximal cavity for mounting onto the mounting base, and a pocket for accepting the proximal portion of an adjacent knuckle therein.

5. The knuckle assembly of claim 4, wherein the proximal portion includes a means for securing the knuckle into position on the mounting base and for un-securing the knuckle sufficiently to permit repositioning of the knuckle on the mounting base.

6. The knuckle assembly of claim 4, wherein the distal portion includes a means for securing the additional percussion instrument hardware in an orientation with respect to the knuckle and for un-securing the additional percussion instrument hardware sufficiently to permit reorientation of the additional percussion instrument hardware with respect to the knuckle.

7. The knuckle assembly of claim 6, wherein the means for securing includes an engaging cam having a radial surface with a substantially similar profile as the distal cavity.

8. The knuckle assembly of claim 4, wherein the proximal cavity is mounted on a central post of the mounting base and securable thereon.

9. The knuckle assembly of claim 8, wherein the at least one knuckle is two knuckles.

10. The knuckle assembly of claim 9, wherein the central post includes a top surface onto which an additional knuckle is securable.

11. A percussion instrument stand, comprising:
a vertical support structure; and
a knuckle assembly configured to couple a percussion instrument to the vertical support structure, the knuckle assembly comprising:
a mounting base configured to be mounted on a vertical support structure, wherein the mounting base is vertically repositionable along the vertical support structure, and
at least one knuckle supported on the mounting base, wherein the at least one knuckle is configured to couple to a percussion instrument, and wherein the at least one knuckle is rotationally repositionable with respect to the vertical support structure.

12. The percussion instrument stand of claim 11, wherein each knuckle is independently repositionable.

13. The percussion instrument stand of claim 11, wherein each knuckle is configured to hold a trial position before being locked into a playing performing position.

14. The percussion instrument stand of claim 11, wherein each knuckle comprises:
a distal portion having a distal cavity for securing additional percussion instrument hardware therein; and
a proximal portion having a proximal cavity for mounting onto the mounting base, and a pocket for accepting the proximal portion of an adjacent knuckle therein.

15. The percussion instrument stand of claim 14, wherein the proximal portion includes a means for securing the knuckle into position on the mounting base and for un-securing the knuckle sufficiently to permit repositioning of the knuckle on the mounting.

16. The percussion instrument stand of claim 14, wherein the distal portion includes a means for securing the additional percussion instrument hardware in an orientation with respect to the knuckle and for un-securing the additional percussion instrument hardware sufficiently to permit reorientation of the additional percussion instrument hardware with respect to the knuckle.

17. The knuckle assembly of claim 14, wherein the proximal cavity is mounted on a central post of the mounting base and securable thereon.

18. The knuckle assembly of claim 17, wherein the at least one knuckle is two knuckles.

19. The knuckle assembly of claim 18, wherein the central post includes a top surface onto which an additional knuckle is securable.

20. The percussion instrument stand of claim 11, wherein the vertical support structure includes a mechanical assist for adjusting the z-axis position of the at least one knuckle.
